(19) United States
(12) Patent Application Publication
(10) Pub. No.: US 2024/0360255 A1
(43) Pub. Date: Oct. 31, 2024

(54) VARIABLE TEMPERATURE TUBULAR REACTOR PROFILES AND INTERMEDIATE DENSITY POLYETHYLENE COMPOSITIONS PRODUCED THEREFROM

(71) Applicant: ExxonMobil Technology and Engineering Company, Baytown, TX (US)

(72) Inventors: Henri A. LAMMENS, Antwerpen (BE); Frankie K.R. VERLUYTEN, Hoeselt (BE)

(21) Appl. No.: 18/686,655

(22) PCT Filed: Aug. 16, 2022
(86) PCT No.: PCT/US2022/075008

§ 371 Date: Feb. 26, 2024

Related U.S. Application Data
(60) Provisional application No. 63/260,827, filed on Sep. 1, 2021.

(51) Int. Cl. C08F 110/02

(52) U.S. Cl. CPC C08F 110/02

(57) ABSTRACT

Methods for polymerizing polyethylene in a tubular reactor may comprise: compressing ethylene monomer to a. pressure from about 2900 bar to about 3150 bar; introducing the compressed ethylene monomer and a modifier into the tubular reactor having two or more reaction zones, wherein each of the two or more reaction zones independently has a peak zonal temperature within a range of about 180° C. to about 300° C.; and producing a polyethylene composition having a density of about 0.9320 g/cm³ to about 0.9350 g/cm3 measured by ASTM D1505-18 using sample preparation according to ASTM 02839-16.

### CROSS-REFERENCE TO RELATED APPLICATION

This application claims the benefit of U.S. Provisional Application 63/260,827, filed Sep. 1, 2021 entitled “VARIABLE TEMPERATURE TUBULAR REACTOR PROFILES AND INTERMEDIATE DENSITY POLYETHYLENE COMPOSITIONS PRODUCED THEREFROM”, the entirety of which is incorporated by reference herein.

### FIELD OF THE INVENTION

The present disclosure relates to processes for control of temperature profiles and modifier concentration in the manufacture of polyethylene at high pressure.

### BACKGROUND OF THE INVENTION

High pressure reactor polymerization plants convert relatively low cost olefin monomers into valuable polyolefin products. The olefins utilized are often ethylene, optionally in combination with one or more comonomers such as vinyl acetate. Standard polymerization processes use oxygen or organic free-radical initiators, such as peroxide initiators, which are known in the art and have been used in industry for a long time. Polymerization takes place at relatively high temperatures and pressures and is highly exothermic. The resulting polymer is a low density polyethylene (LDPE), optionally containing comonomers.

High pressure polymerization processes are carried out in autoclave or tubular reactors. In principle, the autoclave and the tubular polymerization processes are very similar, except for the design of the reactor itself. The plants generally use two main compressors arranged in series, each with multiple stages, to compress the monomer feed. A primary compressor provides an initial compression of the monomer feed, and a secondary compressor increases the pressure generated by the primary compressor to the level at which polymerization takes place in the reactor, which is typically about 210 to about 320 MPa for a tubular reactor and about 120 to about 200 MPa for an autoclave reactor.

A number of process controls and modifiers can be used in high pressure polymerization processes to reduce the molecular weight and narrow the molecular weight distribution. However, temperature spikes and variations in modifier concentrations along the length of the reactor(s) can lead to premature thermal polymerization and polymer build-up in the process piping, which in turn can lead to fouling. Fouling can negatively impact production volume and rates by clogging flow lines, which can cause unfavorable high pressure drops, reduced throughput, and poor pumping efficiency.

A number of approaches have focused on reducing fouling by adding modifier or chain transfer agents at various locations within the reactor. For example, U.S. Pat. No. 6,899,852 discloses a tubular reactor process for obtaining polymers with low haze. The monomer feed streams to the reactor are separated into a transfer-agent-rich stream and a transfer-agent-poor monomer stream, and the transfer-agent-rich stream is fed upstream of at least one reaction zone receiving the transfer-agent-poor monomer stream. The transfer agent-poor monomer stream has 70 wt % or less of the transfer agent relative to the transfer-agent-rich stream, so as to achieve depletion in the concentration of the chain transfer agent in the downstream reaction zone.

When using a chain transfer agent with a high chain transfer constant in known processes, the residual concentration of the agent may be quite low toward the end of the reactor. This can result in production of high molecular weight polymer, causing reduced heat transfer, reduced temperature control, and fouling. Higher temperatures and low chain transfer agent concentrations also increase the number of backbiting reactions and prevalence of short chain branching. As fouling increases, reactor defouls are required to restore heat transfer so that the process can be operated within the desired temperature window for safety and optimized production rates. Reactor defouls may generally involve heating an online reactor to elevated temperatures to melt and release polymer build-up, which can result in production downtime while polymer fouling is disposed of and reactor operating conditions return to normal.

Other background references include U.S. Patent Pubs. 2005/192414, 2012/0220738, 2018/0244813; U.S. Pat. Nos. 3,334,081; 3,546,189; 4,382,132; 7,741,415; 8,450,805; 8,096,433; and 10,844,146; WO 2014/046835, WO 2011/128147, WO 2012/084772, WO 2015/100351, WO 2015/166297, WO 2001/060875, WO 2005/065818, WO 2018/210712, WO 2019/168729, EP1070736, EP1419186, EP2106421, EP2636690, EP3523334, EP3101082, JP4962151, JP5078594, and CN105585647.

### SUMMARY OF THE INVENTION

Methods disclosed herein are directed to the production of medium density polyethylenes (MDPE) in a multi-zonal tubular reactor.

Methods for polymerizing polyethylene in a tubular reactor may comprise: compressing ethylene monomer to a pressure from about 2900 bar to about 3150 bar; introducing the compressed ethylene monomer and a modifier into the tubular reactor having two or more reaction zones, wherein each of the two or more reaction zones independently has a peak zonal temperature within a range of about 180° C. to about 300° C.; and producing a polyethylene composition having a density of about 0.9320 g/cm³ to about 0.9350 g/cm³ measured by ASTM D1505-18 using sample preparation according to ASTM D2839-16.

Methods for polymerizing polyethylene in a tubular reactor may comprise: compressing ethylene monomer to a pressure from about 2900 bar to about 3150 bar; introducing the compressed ethylene monomer and a modifier into the tubular reactor having two or more reaction zones, wherein a cooling zone is present between two of the two or more reaction zones, and wherein a temperature at an end of the cooling zone is about 170° C. or less; and producing a polyethylene composition having a density of about 0.9320 g/cm³ to about 0.9350 g/cm³ measured by ASTM D1505-18 using sample preparation according to ASTM D2839-16.

### BRIEF DESCRIPTION OF THE DRAWINGS

FIG. 1 is a schematic depicting an ethylene polymerization plant or system according to an embodiment of the invention.

FIG. 2 is a temperature profile for a tubular reactor performing a comparative ethylene polymerization process.

FIGS. 3 and 4 are temperature profiles for a tubular reactor performing an ethylene polymerization process in accordance with the present disclosure.

### DETAILED DESCRIPTION OF THE INVENTION

Methods disclosed herein are directed to the production of medium density polyethylenes (MDPE) in a multi-zonal tubular reactor. In an aspect, methods include the use of multiple injection points along the reactor to tune the temperature profile and modifier concentration along the length of the tubular reactor. In another aspect, methods disclosed herein include the production of MDPE that minimizes the formation of long chain branching (LCB) and short chain branching (SCB) and enhances various physical properties.

### Definitions and Test Methods

A “low density polyethylene,” LDPE, is an ethylene polymer having a density of more than 0.90 g/cm³ to less than 0.94 g/cm³. A “medium density polyethylene,” MDPE, is an ethylene polymer having a density in a range of about 0.9320 g/cm³ to about 0.9350 g/cm³. A “high density polyethylene,” HDPE, is an ethylene polymer having a density of 0.94 g/cm³ or more.

Density, reported in g/cm³, is determined in accordance with ASTM 1505-18 (sample preparation according to ASTM D2839-16), where the measurement for density is made in a density gradient column.

As used herein, Mn is number average molecular weight, Mw is weight average molecular weight, and Mz is z-average molecular weight. Polydispersity index (PDI) is defined to be Mw divided by Mn. Unless otherwise noted, all molecular weights (e.g., Mw, Mn, Mz) are reported in units of g/mol.

Gel Permeation Chromatography (GPC) is a liquid chromatography technique used to measure the molecular weight and polydispersity of polymers.

The distribution and the moments of molecular weight (Mw, Mn, Mw/Mn, etc.), the comonomer content and the long chain branching indices (g′) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10 μm Mixed-B LS columns are used to provide polymer separation. Detailed analytical principles and methods are described in paragraphs [0044]-[0059] of PCT Publication WO2019246069A1, which are herein incorporated by reference. Unless specially mentioned, all the molecular weight moments used or mentioned in the present disclosure are determined according to the conventional molecular weight (JR MW) determination methods (e.g., as referenced in Paragraph [0044] of the just-noted publication). The Mark-Houwink parameters needed are calculated from the empirical formula described in the above references according to the comonomer type and contents (if any).

Short Chain Branching (SCB) is determined on the basis of number of short chain branches per 1000 carbon atoms (SCB per 1000C) using ¹³C NMR spectroscopy.

The differential scanning calorimetry (DSC) measurements were performed with TA Instruments' Discovery 2500. Melting point or melting temperature (Tm) was determined by ASTM D3418-15 with samples weighing approximately 2 mg to 5 mg.

Melt index was measured according to ASTM 1238-20 on a Goettfert MI-4 Melt Indexer. Testing conditions were set at 190° C. and 2.16 kg load. An amount of 5 g to 6 g of sample was loaded into the barrel of the instrument at 190° C. and manually compressed. Afterwards, the material was automatically compacted into the barrel by lowering all available weights onto the piston to remove all air bubbles. Data acquisition was started after a 6 min pre-melting time. Also, the sample was pressed through a die of 8 mm length and 2.095 mm diameter.

### Methods of Producing MDPE

In high pressure polyethylene manufacture, control over temperature and modifier concentration represents an ongoing challenge, where polymer properties are dependent on a number of variables including reactant concentration, temperature gradients, and the presence of polymerization additives and modifiers. Higher temperatures and the depletion of modifiers, such as chain transfer agents, may lead to the formation of higher molecular weight and branched polymer by-products and contribute to fouling within the reactor system. Branched polymer by-products produced during free radical polymerization can alter physical properties of the final polymer product, such as melt index, melting point, density, and mechanical strength.

Polymer branching can be subdivided on the basis of size and reaction mechanism into short chain branches (SCB) and long chain branches (LCB). As used herein, SCB are carbon chain branches extending from a primary polymer chain having 10 or less carbons. On the other hand, LCB are carbon chain branches extending from a primary polymer chain having significantly more carbons, in particular, such that the molar mass of the chain is greater than the entanglement molar mass, as described in Porter & Johnson, The Entanglement Concept in Polymer Systems, CHEM. REVIEWS 66:1 (Jan. 25, 1965). This would be expected to be much greater than 20 or even 100 carbon atoms, and therefore readily distinguished from SCB.

SCB can be formed through the incorporation of unsaturated hydrocarbon chain transfer agents. SCB are also formed by backbiting reactions in which the growing polymer chain abstracts a hydrogen from the backbone of the polymer chain, creating an SCB that corresponds to the previous radical site and a new secondary radical site that continues chain growth. It is also possible for multiple backbiting reactions to occur prior to resuming chain growth, which can produce a number of specific SCB types. Commonly formed SCB include methyl branches, butyl branches, 2-ethylhexyl branches, and 1,3-diethyl branches. Due to intermolecular hydrogen transfer, LCB can also be formed on existing polymer molecules, which can then initiate chain propagation, resulting in the formation of LCB through grafting reactions on existing polymer molecules.

The formation of SCB and LCB is influenced by a number of factors that include modifier concentration, modifier type, polymer concentration, reactor pressure and temperature. For example, raising the reactor pressure increases ethylene monomer density and promotes polymerization propagation, decreasing backbiting reactions and SCB formation. In addition, lowering the reactor average temperatures will also reduce LCB and SCB formation. Reduction of branch content for a polymer can result in higher density, higher melting point, and improved crystalline morphology due to increased polymer chain packing and alignment.

Polymerization methods disclosed herein can include enhanced control over branch formation by at least one of: (1) temperature control within one or more reaction zones across the length of the reactor through one or more side streams; and (2) control over polymerization modifier type and concentration that minimizes branch forming reactions during free radical polymerization to produce MDPE. Polymerization processes disclosed herein include the use of a tubular reactor having multiple reaction zones, each reaction zone preferably having independent control over temperature as well as control over concentration of reactants, modifiers, or both.

Temperature control within each reaction zone can include heating and cooling components to maintain the zonal temperature within lower and upper limits. Lower limit zonal temperature control can include the use of preheaters, including steam supplied preheaters, to heat front stream, and/or by external cooling systems, such as a closed utility water system, and/or cold side stream injection of ethylene monomers. Upper limit zonal temperature control is performed by tuning the amount of exothermic energy released during polymerization, and the corresponding temperature within one or more reaction zones, by increasing or decreasing the concentration of reactants, particularly the initiator concentration in said zone.

Methods and systems disclosed herein utilize a tubular reactor having two or more reaction zones where each reaction zone independently has a peak zonal temperature within a range from a low of any one of about 180, 190, or 200° C. to a high of any one of about 225, 240, 290, or 300° C., with ranges from any foregoing low to any foregoing high also contemplated (e.g., 180° C. to 290° C.; such as 180° C. to 240° C.; or 190° C. to 225° C.; or 200° C. to 290° C.). In some embodiments, multi-zonal reactors can be operated such that the temperature in one or more of the late stage reaction zones is elevated with respect to the first reaction zone (or zones) to enhance conversion. Herein, a late-stage reaction zone is not a first reaction zone, and, depending on number of reaction zones, may refer to, e.g., reaction zone n; reaction zone n−1; or reaction zone n−2, where n is the total number of reaction zones, and zone n is the downstream-most zone (the zone closest to reactor discharge); of course, n must correspondingly be at least 2 (for late-stage zone n); or at least 3 (for late-stage zone n, or late stage zones n and n−1); or at least 4 (for late-stage zones comprising n, and optionally n−1, and further optionally n−2); and so-on. In some preferred embodiments, late stage reaction zone(s) refer to either the last (n) reaction zone, or the last (n) and next-to-last (n−1) reaction zone. Methods can include operating one or more late stage reaction zones (e.g., one or more of reaction zones n, n−1, n−2) at a peak temperature above the first reaction zone's peak temperature by at least about 5° C., 6° C., 7° C., 8° C. 9° C. 10° C., 11° C. 12° C., 13° C., 14° C. 15° C., or 20° C. Late stage reaction zone(s) can independently have a peak zonal temperature within a range from a low of any one of about 210, 215, 220, 225, 230, 235, 240, 250, 255, or 260° C. to a high of any one of about 265, 270, 275, 280, 285, 290, 295, or 300° C., with ranges from any foregoing low to any foregoing high also contemplated (e.g., 210° C. to 290° C., such as 210° C. to 240° C., or 230° C. to 270° C., or 260° C. to 290° C.). In some instances, the late stage reaction zone(s) may have the highest peak zonal temperature(s) of all the reaction zones. The non-late-stage reaction zone(s) (i.e., those other than the n, n−1, and/or n−2 reaction zones) may each have peak zonal temperature within the range from 180° C. to 245° C., such as from a low of any one of 180, 190, or 200° C. to a high of any one of 220, 225, 230, 235, or 240° C., with ranges from any foregoing low to any foregoing high contemplated (e.g., 180° C. to 225° C.).

Tubular reactors disclosed herein can also include multiple reaction zones, wherein the concentration of reactants to each of the multiple zones is controlled by a single pump with a flow controller for the various locations, or alternatively controlled with separate pumps (e.g., a pump for each zone; or a pump for each reactant to the multiple zones; or each zone having a pump for each reactant). Reaction zones can include one or more inlets for the delivery of various reagents, including initiators, monomers, and modifiers, supplied by one or more pumps capable of achieving inlet pressures ranging between about 2900 bar and about 3150 bar, depending on the pressure within the tubular reactor.

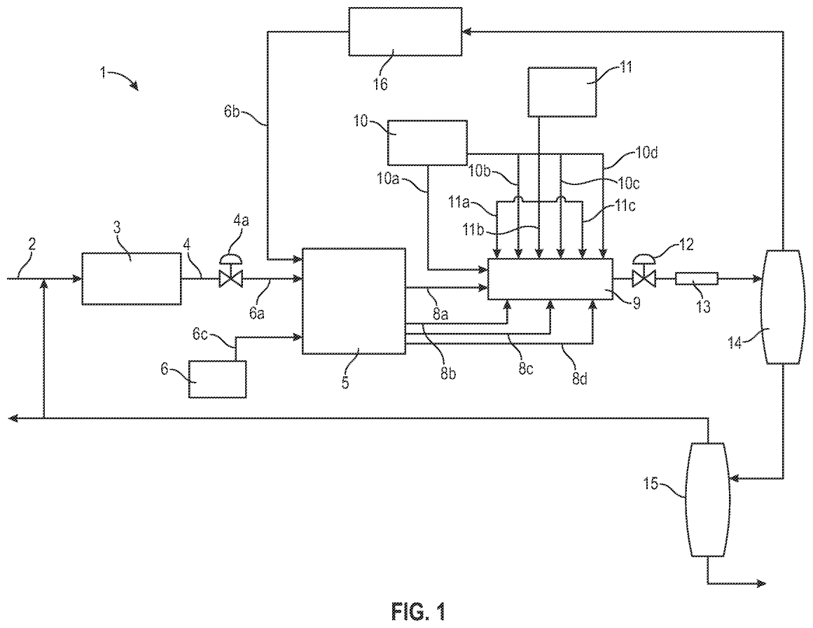

FIG. 1 is a schematic depicting an embodiment of a polymerization plant 1 configured in accordance with the present disclosure. Polymerization plant 1 includes an ethylene feed line 2 which supplies fresh ethylene to a primary compressor 3. The function of the primary compressor 3 is to pressurize fresh ethylene (or make-up ethylene) up to the pressure of the high-pressure ethylene recycle system (discussed in more detail below, resulting in recycle stream 6b), to feed the secondary compressor 5. The primary compressor 3 may be a single compressor that pressurizes the ethylene alone or it may be two or more compressors in series or in parallel that, in combination, pressurize the ethylene to the pressure of the ethylene recycle stream 6b. In some embodiments, a polymerization plant 1 can be configured such that ethylene is discharged from the primary compressor 3 and divided into two streams (not shown), one stream being combined with recycled ethylene (e.g., in line 6b) and fed to the suction of the secondary compressor 5, and the other stream being injected into an ethylene/polymer mixture downstream of the high-pressure let-down valve 12, thereby providing rapid cooling of the ethylene/polymer mixture prior to entry into the product separation unit 14.

As shown in FIG. 1, the ethylene discharged from the primary compressor 3 flows via conduit 4 having a valve 4a to conduit 6a and then to the secondary compressor 5. Recycled ethylene is also supplied to the secondary compressor 5 via conduit 6b from a high pressure recycle system 16. The secondary compressor compresses the ethylene to a pressure of at least 2900 bar for supply to the reactor 9. The secondary compressor 5 can be driven by a single motor, or an arrangement of two or more compressors in series or in parallel driven by separate motors (not shown). Any configuration of compressors is intended to be within the scope of this disclosure as long as said configuration is adapted to compress the ethylene from the pressure of the ethylene as it leaves the primary compressor 3 to the desired reactor pressure in the range of from about 2900 bar to about 3150 bar.

The secondary compressor 5 discharges compressed ethylene in four streams 8a, 8b, 8c, and 8d. Stream 8a may account for about 15%, 20%, about 33%, about 50%, or another amount of the total ethylene flow. Stream Sa may be heated by a steam jacket (not shown) prior to entry into the front end of the reactor 9. The three remaining ethylene streams 8b, 8c, and 8d each enter the reactor as side streams, where temperature within the streams can be adjusted (heated or cooled) prior to entry to the reactor 9. While the example reactor 9 in FIG. 1 is shown with 3 side streams 8b, 8c, and 8d (with feed stream 8a, 4 total streams), it is also within the scope of this disclosure that a reactor may be utilized having more or less side streams, such as a range of 2 to 4, 5, 6, or 7 side streams (for a total of 3, 4, 5, 6, 7, or 8 ethylene streams).

The reactor 9 has an initiator pumping station 11 for injecting initiator into the reactor through initiator streams 11a, 11b, and 11c. The reactor 9 can include multiple reaction zones that are defined by initiator inlets 11a, 11b, and 11c. While polymerization plant 1 depicts reactor 9 having three zones, reactors incorporating additional zones, such as 4 to 6 or more zones, are within the scope of this disclosure (including correspondingly more initiator streams).

As initiator is consumed within the reaction zones injected through streams 11a, 11b, and 11c, an exothermic temperature rise as the polymerization reaction is initiated downstream of the inlet, which decreases as the initiator is consumed and heat is dissipated through cooling. In FIG. 1, ethylene side stream 8b defines the end of the first reaction zone and the start of the first cooling zone. Similarly, initiator stream 11b defines the start of the second reaction zone and ethylene side stream 8c defines the start of the second cooling zone. In some embodiments, the cooling in a cooling zone may be effected through a cooling jacket (not shown) fitted on the reactor 9, where said cooling zone may or may not include an ethylene side stream. When a cooling jacket and ethylene side stream are both included, the beginning of a cooling zone is defined by the most upstream of the two. If the cooling zone includes only a cooling jacket, the beginning of the cooling zone is defined by the beginning of the cooling jacket. The end of a cooling zone may have a temperature of about 170° C. or less, about 160° C. or less, or about 150° C. or less. The end of a cooling zone may have a temperature in the range of 130° C. to about 170° C., about 140° C. to about 165° C., or about 145° C. to about 165° C.

The manner and timing of the introduction of the modifiers (e.g., chain transfer agent or CTA) and/or other additives into the reactor 9 can vary widely, and often involve introducing the modifier and/or ethylene in at least two reaction zones. While examples herein are discussed with respect to modifiers, delivery of alternative additives and component mixtures are also within the scope of the disclosure. During polymerization within the reactor 9, modifiers are fed along with ethylene and other reaction components such as comonomers, initiators, additives, etc. into one or more reaction zones. Additional modifier (or make-up modifier) can also be added alone or as a mixture to replace modifier consumed in the first reaction zone to downstream (2nd, 3rd, 4th, etc.) reaction zones.

The example polymerization plant 1 is equipped with a pumping station 10 for delivering additives (such as modifiers) at various locations along the length of the reactor 9, including front stream 10a, and side streams 10b, 10c, and 10d. Pumping station 10 feeds modifiers by way of a flow controller (not shown) that tailors the amount of modifier fed through each stream. The additional injection points over prior processes also can reduce the amount of modifier that must be added in any one injection point, avoiding undesired localized high concentrations of modifier. In some embodiments, the feed can include a mixture of initiator and modifier that is fed through one or more of the front stream 10a and three side streams 10b, 10c, and 10d, eliminating the need for a separate initiator pumping station 11 and streams (e.g., per FIG. 1, streams 11a, 11b, and 11c). Additionally or instead, modifier can be supplied to the reactor system from modifier pump 6 via conduit 6c to the discharge or suction of the second stage of the secondary compressor 5 and delivered to reactor 9 as a mixture with ethylene.

Following polymerization, the reactor 9 terminates at a high-pressure, let-down valve 12, which controls pressure within the reactor 9. Downstream of the high-pressure, let-down valve 12 is product cooler 13, where the polymerization reaction mixture is phase separated and exits into high pressure separator 14. The overhead gas from the high pressure separator 14 flows into the high pressure recycle system 16 where the unreacted ethylene is cooled and returned to the secondary compressor 5. The separated polymer product flows from the bottom of the high pressure separator 14 into the low pressure separator 15, which separates almost all of the remaining ethylene from the polymer. The remaining ethylene can be recycled to the primary compressor 3, or processed using a number of known techniques such as a flare (not shown) or a purification unit (not shown). Molten polymer flows from the bottom of the low pressure separator 15 to downstream processing equipment, which may include, for example, an extruder (not shown) for extrusion, cooling, and pelletizing.

The proportion of the total ethylene which enters the reactor 9 through one or more of the main feed stream 8a or as a side stream 8b, 8c, or 8d that is converted to polymer before exiting the reactor 9 is referred to as the conversion. Conversion rates in accordance with the present disclosure can be from 30% to 40%, or at least about 35%. Conversions of higher than 40% are feasible, but can be associated with an increase in the pressure drop to maintain flow velocity of the higher viscosity polymer product. The ethylene polymer product manufactured according to the invention may have a density from a low of any one of about 0.930, 0.931, 0.932, 0.9325, or 0.933 g/cm³ to a high of any one of about 0.934, 0.935, 0.936, 0.937, 0.938, 0.939, or 0.940 g/cm³, with a melt index within the range from a low of about 0.1, 0.2, 0.3, 0.4, or 0.5 dg/min to a high of about 1, 2, 3, 5, 10, 15, or 20 dg/min. Ranges from any foregoing low density or melt index to any foregoing high density or melt index are contemplated herein (e.g., 0.932 to 0.935 g/cm³ and 0.1 to 20 dg/min melt index).

Polymerization processes described herein can produce ethylene homopolymers, and can also be adapted to produce comonomers, such as ethylene-vinyl acetate copolymers. During production of copolymers, comonomer(s) can be pressurized and injected into the secondary compressor 5 at one or more points. Other possible comonomers include propylene, 1-butene, iso-butene, 1-hexene, 1-octene, other lower alpha-olefins, methacrylic acid, methyl acrylate, acrylic acid, ethyl acrylate and n-butyl acrylate. Reference herein to “ethylene” should be understood to include ethylene and comonomer mixtures, except where another meaning is implied by context.

### Initiators

The term “initiator” as used herein refers to a compound that initiates the free radical ethylene polymerization process. Initiators disclosed herein include species that generate free radicals at temperatures that include the lower limit of the zonal temperature ranges within the reactor. For example, initiators can include species having an activation temperature at which it generates free radicals within a range of about 130° C. to about 300° C. However, depending on the operating temperatures within a given reactor or zone, initiators having higher or lower activation temperatures may be selected.

Suitable initiators for use in polymerization processes disclosed herein include, but are not limited to, peroxide initiators such as pure peroxide; peresters including, but not limited to, bis(2 ethylhexyl)peroxydicarbonate, tert-Butyl per(2-ethyl)hexanoate, tert-Butyl perpivalate, tert-Butyl perneodecanoate, tert-Butyl perisobutyrate, tert-Butyl per-3,5,5,-trimethylhexanoate, tert-Butyl perbenzoate; and dialkyl peroxides including, but not limited to, di-tert-butyl peroxide, and mixtures thereof.

Initiators disclosed herein can be formulated in one or more hydrocarbon solvents. Delivery of the initiators to a reactor can be at one or more injection locations as described herein. Any suitable pump may be used, for example, a hydraulically driven piston pump.

Initiators disclosed herein can be used at a concentration of initiator per tonne (1000 kg) of polyethylene of about 0.7 kg or less, about 0.6 kg or less, or 0.5 kg or less. Initiators disclosed herein can be used at a concentration of initiator per tonne of polyethylene of about 0.2 kg to about 2.0 kg, about 0.3 kg to about 1.5 kg, or about 0.5 to about 1.5 kg.

### Modifier

The term “modifier” as used herein refers to a compound added to the process to control the molecular weight and/or melt index of a produced polymer. The term “chain transfer agent” is interchangeable with the term “modifier” as used herein. “Chain transfer” involves the termination of growing polymer chains, which limits the ultimate molecular weight of the polymer material. Modifiers are often hydrogen atom donors that react with a growing polymer chain and stop the polymerization reaction of the chain. Tuning the concentration of modifiers in accordance with the present disclosure can be used to control reaction propagation, melt index, and molecular weight distributions in a free-radical polymerization process.

Chain transfer constants are used to quantify the relative rates of chain transfer reactions. Table 1 gives an overview of suitable modifiers and their respective chain transfer activity (Ctr) constants, which is calculated as the ratio of the rate of a chain transfer reaction compared to the propagation reaction (ktr/kp). For further details regarding polymerization modifiers, see Advances in Polymer Science. Vol. 7, pp. 386-448 (1970).

TABLE 1
Overview of Ctr constants for selected
CTAs used in production of polyethylene

| CTA | Ctr |
|---|---|
| Ethane | 0.0006 |
| Methanol | 0.0021 |
| n-butane | 0.0049 |
| Hexane | 0.0067 |
| Propylene | 0.1220 |
| Isobutylene | 0.2060 |
| 1-butene | 0.0470 |
| Ethylbenzene | 0.0520 |
| Propionaldehyde | 0.4000 |

*Ctr determined at 1380 bar and 130° C., except for propionaldehyde, which was estimated at 1380 bar and 200° C.

In addition to controlling the average chain length of growing polymer chains, modifiers can also be used to modify the number of SCB and LCB and the overall density of the polyethylene. Particularly, branching resulting from modifier incorporation can be minimized through the use of saturated hydrocarbon modifiers, or modifiers having a relatively high Ctr, such as aldehydes. For saturated hydrocarbon modifiers, branching reactions are reduced because the molecules contain no double bonds or sites of unsaturation capable of incorporating with a growing polymer chain to form branches. On the other hand, modifiers having a high chain transfer activity can be used at lower concentrations to control MI, lowering the overall to number of potential branching reactions. Further, by selecting a modifier having high chain transfer activity, conversion can be enhanced by running slightly elevated reactor peak temperatures for similar resin densities.

Modifiers useful in processes described herein include C2 to C20 saturated hydrocarbons (e.g., ethane, propane, butane, isobutane, pentane, hexane, and the like) or C1 to C10 aldehydes (e.g., formaldehyde, acetaldehyde, propionaldehyde, butyraldehyde, furfuraldehyde, glucose, benzaldehyde, cinnamaldehyde, and the like).

Suitable modifiers have a Ctr determined at 1380 bar and 200° C. of about 0.6 or less, about 0.5 or less, or about 0.45 or less; or, more particularly, a Ctr determined at 1380 bar and 200° C. within the range from a low of any one of about 0.0001, 0.0003, or 0.0005 to a high of any one of about 0.45, 0.50, or 0.60, with ranges from any foregoing low to any foregoing high contemplated herein. Methods can also include the use of one or more modifiers having a Ctr determined at 1380 bar and 130° C. of about 0.007 or less, 0.009 or less, or 0.010 or less; and/or a Ctr determined at 1380 bar and 200° C. of about 0.3 or more, about 0.35 or more, or about 0.4 or more.

In an embodiment of the invention, the modifier may be present in the invention in the amount of up to 5 kg per tonne of polyethylene, or from 0.5 kg to 5 kg per tonne of polyethylene, or from 1 kg to 5 kg per tonne of polyethylene, or from 2 kg to 5 kg per tonne of polyethylene, or from 3 kg to 5 kg per tonne of polyethylene, or from 4 kg to 5 kg per tonne of polyethylene.

### Physical Properties

Polyethylene compositions disclosed herein can have density and melt index within the ranges previously described in connection with discussion of FIG. 1 above.

In addition, polyethylene compositions disclosed herein can have a melting point within a range of about 110° C. to about 125° C., about 112° C. to about 120° C., or about 115° C. to about 120° C., with ranges from any foregoing low to any foregoing high also contemplated (e.g., 110° C. to 120° C.).

Polyethylene compositions disclosed herein can have short chain branching (SCB) per 1000 carbon atoms as determined by ¹³C NMR in a range from a low of any one of about 2, 3, 4, or 5 to a high of any one of about 8, 9, 10, 11, 12, 13, 14, or 15, with ranges from any foregoing low to any foregoing high contemplated (e.g., 3 to 14, or 5 to 12). Further, SCB per 1000 can also be characterized in terms of the sum of methyl, ethyl, butyl, amyl, 2 ethyl C6 and 2 ethyl C7 chains, as determined by ¹³C NMR; such sum can be within the range from 2, 3, or 4 to 7, 8, 9, 10, or 11.

Polyethylene compositions disclosed herein can have a weight average molecular weight ranging from about 45,000 Da to about 650,000 Da, about 50,000 Da to about 550,000 Da, or about 50,000 Da to about 500,000 Da, with ranges from any foregoing low to any foregoing high also contemplated (e.g., 45,000 to 500,000 Da). Polyethylene compositions disclosed herein can have a polydispersity index (M_{w}/Mₙ) in a range from about 1 or 2, to a high of about 4 or 5.

### Applications

Polyethylene compositions prepared by the methods disclosed herein can exhibit improved optics, shrink tension, high stiffness, high tensile modulus, die cutting, and heat resistance when compared to standard LDPE. End-use products made using the disclosed ethylene-based polymers include all types of films (for example, blown, cast and extrusion coatings (monolayer or multilayer)), molded articles (for example, blow molded and rotomolded articles), wire and cable coatings and formulations, cross-linking applications, foams (for example, blown with open or closed cells), and other thermoplastic applications.

### Example Embodiments

A first nonlimiting example embodiment is a method for polymerizing polyethylene in a tubular reactor, the method comprising: compressing ethylene monomer to a pressure from about 2900 bar to about 3150 bar; introducing the compressed ethylene monomer and a modifier into the tubular reactor having two or more reaction zones, wherein each of the two or more reaction zones independently has a peak zonal temperature within a range of about 80° C. to about 300° C.; and producing a polyethylene composition having a density of about 0.9320 g/cm³ to about 0.9350 g/cm³ measured by ASTM D1505-18 using sample preparation according to ASTM D2839-16. The first nonlimiting example embodiment may further include one or more of: Element 1: wherein the polyethylene composition has a melt index measured by ASTM D1238-20 of about 0.1 dg/min to about 20 dg/min; Element 2: wherein the modifier comprises one or more C2 to C20 saturated hydrocarbons; Element 3: Element 2 and wherein each of the two or more reaction zones independently has a peak zonal temperature within a range of about 190° C. to about 225° C.; Element 4: wherein the modifier comprises one or more C1 to C10 aldehydes; Element 5: Element 4 and wherein each of the two or more reaction zones independently has a peak zonal temperature within a range of about 200° C. to about 300° C. (or about 200° C. to about 290° C.); Element 6: wherein the modifier has a chain transfer activity (Ctr) determined at 1380 bar and 130° C. of 0.009 or less; Element 7: wherein the modifier has a chain transfer activity (Ctr) determined at 1380 bar and 200° C. of 0.300 or more; Element 8: Element 7 and wherein a late stage reaction zone of the two or more reaction zones operate at a temperature above that of a first reaction zone of the two or more reaction zones by at least about 5° C.; Element 9: Element 7 and wherein a late stage reaction zone of the two or more reaction zones operate at a temperature above that of a first reaction zone of the two or more reaction zones by at least about 20° C.; Element 10: wherein the polyethylene composition has a melting point as measured by ASTM D3418-15 within a range of about 112° C. to about 120° C.; Element 11: wherein the polyethylene composition has a weight average molecular weight ranging from about 50,000 Da to about 500,000 Da; Element 12: wherein the polyethylene composition has a short chain branching (SCB) per 1000 carbon atoms in a range of about 2 to about 14, such as about 3 to about 12; Element 13: wherein the polyethylene composition has a sum of methyl, ethyl, butyl, amyl, 2 ethyl C6, and 2 ethyl C7 short chain branches per 1000 carbon atoms in a range of about 2 to about 10, such as 3 to about 9; Element 14: the method further comprising adding an initiator to the tubular reactor; Element 15: Element 14 and wherein the initiator and the modifier are premixed prior to addition to the tubular reactor; and Element 16: Element 14 and wherein the initiator has an activation temperature in a range of about 130° C. to about 300° C. Examples of combinations include, but are not limited to, Element 1 in combination with one or more of Elements 2-16; Element 2 (optionally in combination with Element 3) in combination with one or more of Elements 4-16; Element 4 (optionally in combination with Element 5) in combination with one or more of Elements 6-16; Element 7 (optionally in combination with one or both of Elements 8 and 9) in combination with one or more of Elements 10-16; Element 10 in combination with one or more of Elements 11-16; Element 11 in combination with one or more of Elements 12-16; Element 12 in combination with one or more of Elements 13-16; Element 13 in combination with one or more of Elements 14-16; and Element 14 in combination with one or both of Elements 15 and 16.

A second nonlimiting example embodiment is a method for polymerizing polyethylene in a tubular reactor, the method comprising: compressing ethylene monomer to a pressure from about 2900 bar to about 3150 bar; introducing the compressed ethylene monomer and a modifier into the tubular reactor having two or more reaction zones, wherein a cooling zone is present between two of the two or more reaction zones, and wherein a temperature at an end of the cooling zone is about 170° C. or less; and producing a polyethylene composition having a density of about 0.9320 g/cm³ to about 0.9350 g/cm³ measured by ASTM D1505-18 using sample preparation according to ASTM D2839-16. The second nonlimiting example may further include one or more of: Element 17: wherein each of the two or more reaction zones independently has a peak zonal temperature within a range of about 180° C. to about 240° C., and wherein the modifier comprises one or more C2 to C20 saturated hydrocarbons; Element 18; wherein each of the two or more reaction zones independently has a peak zonal temperature within a range of about 190° C. to about 225° C., and wherein the modifier comprises one or more C2 to C20 saturated hydrocarbons; Element 19: Element 17 or Element 18 and wherein the two or more reaction zones comprises a late stage reaction zone with the peak zonal temperature being within a range of about 210° C. to about 240° C. (or about 210° C. to about 225° C.); Element 20: Element 19 and wherein the late stage reaction zone is the last reaction zone; Element 21: wherein each of the two or more reaction zones independently has a peak zonal temperature within a range of about 180° C. to about 300° C. (or about 180° C. to about 290° C.), and wherein the modifier comprises one or more C1 to C10 aldehyde; Element 22: wherein each of the two or more reaction zones independently has a peak zonal temperature within a range of about 200° C. to about 300° C. (or about 200° C. to about 290° C.), and wherein the modifier comprises one or more C1 to C10 aldehyde; Element 23: Element 21 or Element 22 wherein the two or more reaction zones comprises a late stage reaction zone with the peak zonal temperature being within a range of about 260° C. to about 300° C. (or about 260° C. to about 290° C.); Element 24: Element 23 and wherein the late stage reaction zone is the last reaction zone; Element 25: wherein the two or more reaction zones comprise a late stage reaction zone having the highest peak zonal temperature of the two or more reaction zones; Element 26: the method further comprising: injecting a portion of the compressed ethylene monomer at a beginning of the cooling zone; Element 27: wherein a cooling jacket is associated with the cooling zone; and Element 28: the method further comprising: injecting an initiator at the end of the cooling zone. Examples of combinations may include, but are not limited to. Element 17 or Element 18 (each optionally in combination with Element 19 and optionally in further combination with Element 20) in combination with one or more of Elements 25-28; Element 21 or Element 22 (each optionally in combination with Element 23 and optionally in further combination with Element 24) in combination with one or more of Elements 25-28; and two or more of Elements 25-28 in combination.

### EXAMPLES

To facilitate a better understanding of the embodiments of the present invention, the following examples of preferred or representative embodiments are given. In no way should the following examples be read to limit, or to define, the scope of the invention.

### Example 1: Preparation of a Comparative LDPE and MDPE

Reactor conditions, melting point and short chain branching distribution for LDPEs made on tubular reactors are shown in Table 2, where branching values are expressed in groups per 1000 carbon atoms. Short chain branching values were determined by ¹³C NMR. As shown in the Table 2, lower temperature and higher pressure of the tubular reactor suppresses the sequential backbiting mechanism to 2 ethyl-hexyl/heptyl.

TABLE 2
Polymer properties for Example 1

| | Comparative LDPE | Ex. MDPE |
|---|---|---|
| Resin | Resin | Resin |
| Tubular P (bar) | 3000 | 3050 |
| Temperature avg (° C.) | 252 | 192 |
| Melting point (° C.) | 107.5 | 116.2 |
| Density (g/cm³) | 0.922 | 0.933 |
| Methyl (per 1000 C) | 4.2 | 0 |
| Ethyl (per 1000 C) | 4.45 | 2.15 |
| Butyl (per 1000 C) | 5.95 | 4.2 |
| Amyl (per 1000 C) | 2.25 | 1.7 |
| 2 Ethyl C6 (per 1000 C) | 1.1 | 0.00 |
| 2 Ethyl C7 (per 1000 C) | 1.1 | 0.00 |
| Total SCB (per 1000 C) | 14.85 (+4.2 methyl) | 8.05 |
| C6+ (per 1000 C) | 3.0 | 3.0 |

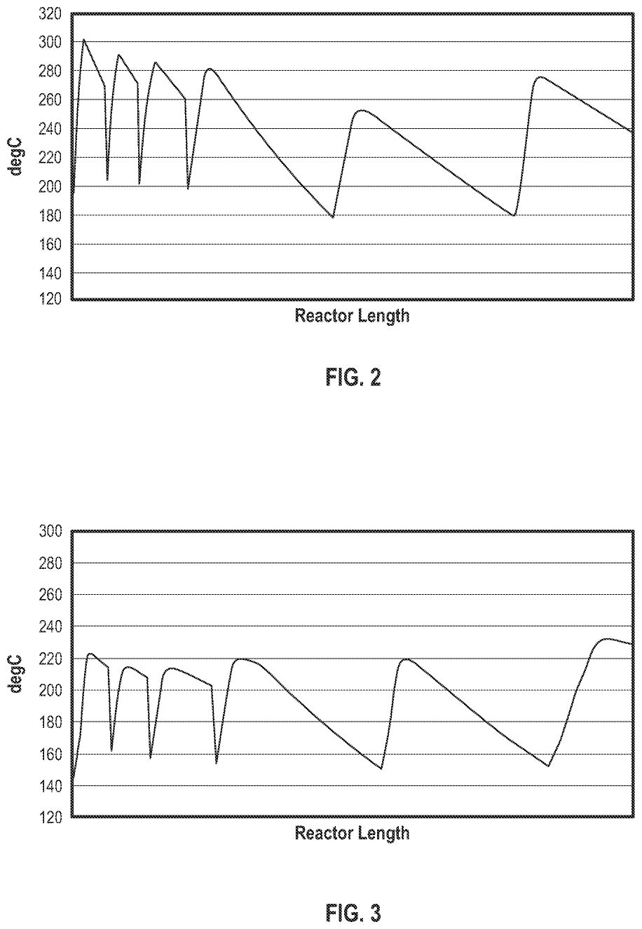

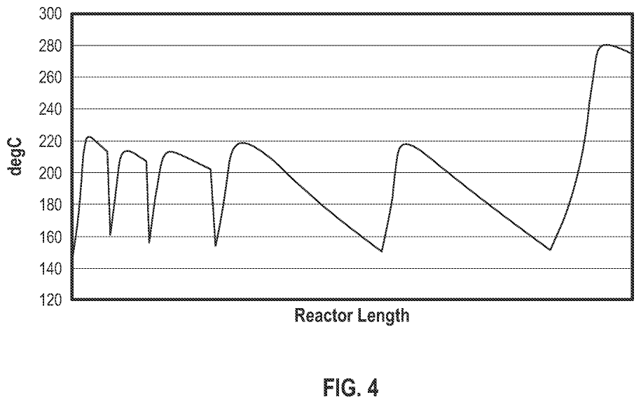

The temperature profiles for the comparative LDPE and example MDPE resins are shown in FIGS. 2-3. FIG. 2 shows the temperature profile for the comparative LDPE prepared under standard temperature conditions using propylene as a modifier and at a reaction pressure of 3000 bar. FIG. 3 shows the temperature profile for the MDPE prepared in accordance with the present disclosure using hexane as a modifier, and at a reactor pressure of 3050 bar.

### Example 2: Production of MDPE with a Higher Activity Modifier

A medium density polyethylene was formed under substantially similar conditions to those listed in Example 1 at a reaction pressure of 3050 bar, with the exception that propionaldehyde was selected as a modifier. Further, due to the larger chain transfer constant (Ctr) for propionaldehyde, the conversion loss is offset by increasing the temperature of the final reaction zone. Temperature profile results are shown in FIG. 4. The density of the produced MDPE was comparable to Resin 2 from Example 1 and a conversion gain of 5% absolute was observed.

Certain embodiments and features have been described using a set of numerical upper limits and a set of numerical lower limits. It should be appreciated that ranges from any lower limit to any upper limit are contemplated unless otherwise indicated. Certain lower limits, upper limits, and ranges appear in one or more claims below. All numerical values are “about” or “approximately” the indicated value, and take into account experimental error and variations that would be expected by a person having ordinary skill in the art.

To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form. “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method for polymerizing polyethylene in a tubular reactor, the method comprising:
compressing ethylene monomer to a pressure from about 2900 bar to about 3150 bar;
introducing the compressed ethylene monomer and a modifier into the tubular reactor having two or more reaction zones, wherein each of the two or more reaction zones independently has a peak zonal temperature within a range of about 180° C. to about 300° C.; and
producing a polyethylene composition having a density of about 0.9320 g/cm³ to about 0.9350 g/cm³ measured by ASTM D1505-18 using sample preparation according to ASTM D2839-16.

2. The method of claim 1, wherein the polyethylene composition has a melt index measured by ASTM D1238-20 of about 0.1 dg/min to about 20 dg/min.

3. The method of claim 1, wherein the modifier comprises one or more C2 to C20 saturated hydrocarbons.

4. The method of claim 1, wherein the modifier has a chain transfer activity (Ctr) determined at 1380 bar and 130° C. of 0.009 or less.

5. The method of claim 3, wherein each of the two or more reaction zones independently has a peak zonal temperature within a range of about 190° C. to about 235° C.

6. The method of claim 5, wherein a late stage reaction zone of the two or more reaction zones operates at a peak temperature within a range of 225° C. to 235° C.; and each other reaction zone operates at a peak temperature within a range of 190° C. to 225° C.; further wherein the late stage reaction zone operates at a peak temperature above that of a first reaction zone of the two or more reaction zones by at least 5° C.

7. The method of claim 3, wherein a late stage reaction zone of the two or more reaction zones operates at a peak temperature above that of a first reaction zone of the two or more reaction zones by at least 5° C.

8. The method of claim 7, wherein the late stage reaction zone is the last reaction zone of the two or more reaction zones.

9. The method of claim 7, wherein there are three or more reaction zones, and the late stage reaction zone is either the last or the next-to-last reaction zone.

10. The method of claim 1, wherein the modifier comprises one or more C1 to C10 aldehydes.

11. The method of claim 1, wherein the modifier has a chain transfer activity (Ctr) determined at 1380 bar and 200° C. of 0.300 or more.

12. The method of claim 10, wherein each of the two or more reaction zones independently has a peak zonal temperature within a range of about 200° C. to about 300° C.

13. The method of claim 12, wherein a late stage reaction zone of the two or more reaction zones operates at a peak temperature within a range of 260° C. to 300° C.; and each other reaction zone operates at a peak temperature within a range of 200° C. to 225° C.; further wherein the late stage reaction zone operates at a peak temperature above that of a first reaction zone of the two or more reaction zones by at least 20° C.

14. The method of claim 10, wherein a late stage reaction zone of the two or more reaction zones operates at a peak temperature above that of a first reaction zone of the two or more reaction zones by at least 20° C.

15. The method of claim 1, wherein the polyethylene composition further has one or more of the following properties:
(a) a melting point as measured by ASTM D3418-15 within a range of about 112° C. to about 120° C.; and
(b) a short chain branching (SCB) per 1000 carbon atoms in a range of 2 to 14; and
(c) a sum of methyl, ethyl, butyl, amyl, 2 ethyl C6, and 2 ethyl C7 branches per 1000 carbon atoms, as detected by ¹³C NMR, within a range of 2 to 10.

16. A method for polymerizing polyethylene in a tubular reactor, the method comprising:
compressing ethylene monomer to a pressure from about 2900 bar to about 3150 bar;
introducing the compressed ethylene monomer and a modifier into the tubular reactor having two or more reaction zones, wherein a cooling zone is present between two of the two or more reaction zones, and wherein a temperature at an end of the cooling zone is about 170° C. or less; and
producing a polyethylene composition having a density of about 0.9320 g/cm³ to about 0.9350 g/cm³ measured by ASTM D1505-18 using sample preparation according to ASTM D2839-16.

17. The method of claim 16, wherein each of the two or more reaction zones independently has a peak zonal temperature within a range of about 180° C. to about 240° C., and wherein the modifier comprises one or more C2 to C20 saturated hydrocarbons.

18. The method of claim 16, wherein each of the two or more reaction zones independently has a peak zonal temperature within a range of about 180° C. to about 300° C., and wherein the modifier comprises one or more C1 to C10 aldehyde.
